(19) United States
(12) Patent Application Publication
(10) Pub. No.: US 2007/0137014 A1
(43) Pub. Date: Jun. 21, 2007

(54) Methods, systems, and apparatus for finishing a vehicle seat component

(76) Inventor: David A. Montgomery, Winder, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/635,842

(22) Filed: Dec. 8, 2006

Related U.S. Application Data
(60) Provisional application No. 60/748,913, filed on Dec. 8, 2005.

(51) Int. Cl. B68G 7/00

(52) U.S. Cl. 29/91; 29/91.1; 29/91.7

(57) ABSTRACT

The present invention relates to methods, systems, and apparatus for finishing an upholstered component, such as a vehicle seat component. A finishing process is provided wherein undesirable features in the material of the seat component, such as wrinkles, creases, sewing pucker, marks, and the like, can be removed. Embodiments of the present invention can include an inflatable bag capable of receiving a seat component, a form area capable of receiving the inflatable bag, an air or gas system capable of inflating the inflatable bag, a tensioning system capable of providing a force on the form area, and a steam supply system capable of providing steam to the seat component mounted to a portion of the inflatable bag. A seat component removal system may be provided that can remove the seat component after the finishing process is complete.

### CROSS-REFERENCE TO RELATED APPLICATIONS

This application claims priority to U.S. Provisional Patent Application No. 60/748,913, filed Dec. 8, 2005, which is incorporated herein by reference in its entirety.

### FIELD OF THE INVENTION

The invention relates generally to the field of vehicle components, and more particularly, relates to methods, systems, and apparatus for finishing a vehicle seat component.

### BACKGROUND OF THE INVENTION

Many types of vehicles, such as automobiles, trucks, vans, utility vehicles, buses, construction equipment, aircraft, and marine craft, can include seats. Vehicle seats can include multiple components such as seat covers, seat back covers, seat cushion covers, head rest covers, arm rest covers, and the like. Prior to installation and use in a vehicle, vehicle seats, such as seats for an automobile, can undergo a variety of manufacturing and assembly or sub-assembly processes, such as a finishing process.

One assembly process for a seat cover, such as a vehicle seat cover, can involve the removal of undesirable features in the material, such as wrinkles, creases, sewing pucker, marks, and the like. Conventional assembly processes can include the use of a manually operated steam iron to remove undesirable features. An operator can manually press a heated steam iron or other steaming device against one or more components of a vehicle seat, such as a seat cover, when an undesirable feature such as a wrinkle, is detected in the seat cover. The heated steam iron or other steaming device can flatten and remove the undesirable feature. This type of manually performed conventional process can be time consuming. Furthermore, such processes may lack quality control over the finished product due to the dependency of the particular process on the operator's skill and use of the iron or other steaming device.

Therefore, a need exists for methods, systems, and apparatus for finishing a vehicle seat component.

### SUMMARY OF THE INVENTION

Some or all of the needs can be addressed by embodiments of the present invention. Embodiments of the present invention can improve the quality of a finished upholstered components, such as for example vehicle seat component. Embodiments of the invention can provide a system for finishing an upholstered component, such as a vehicle seat cover. The system can include an inflatable bag capable of connecting or associating with a seat component, a form area capable of connecting or associating with the inflatable bag, an air or gas system capable of inflating the inflatable bag, a tensioning system capable of providing a force on the form area, and a steam supply system capable of providing steam to the seat component mounted to a portion of the inflatable bag. A user or operator can select or otherwise operate the system via a set of instructions or a computer software program to implement a process for finishing a seat component using the system. The user or operator can position or mount the seat component on the inflatable bag, and can clamp the seat component relative to the inflatable bag via operation of a foot pedal. Once the position of the seat component relative to the inflatable bag is established, one or more tensioning, steaming, and air processes or cycles can be implemented by the system. When some or all of these processes or cycles are completed, the seat component can be unloaded and positioned for removal to another area by the user or operator. In this manner, the seat component can undergo a finishing process wherein undesirable features in the material of the seat component, such as wrinkles, creases, sewing pucker, marks, and the like, can be removed.

One aspect of the invention can include a method for finishing a vehicle seat component. The method can include mounting a seat component relative to an inflatable bag and form area. The method can also include securing the position of the seat component relative to the inflatable bag and the form area. In addition, the method can include providing a tensioning force to the form area, wherein a portion of the tensioning force is applied to the seat component. Moreover, the method can include providing air to the inflatable bag, wherein a portion of the air is applied to the seat component. Furthermore, the method can include applying steam to the seat component. Further, the method can include whereby application of the tensioning force, air, and steam can be simultaneously applied to the seat component.

Other aspects and embodiments of systems, methods, and apparatus according to the invention are apparent from the following detailed description of the disclosed embodiments and the appended drawings and claims.

### BRIEF DESCRIPTION OF THE DRAWINGS

FIG. 1 is an exemplary upholstered component finishing system in accordance with an embodiment of the present invention.

FIG. 2 is another view of the upholstered component finishing system of FIG. 1.

FIG. 3 illustrates another view of the upholstered component finishing system shown in FIGS. 1 and 2.

FIGS. 4A-4D illustrate an example of an associated upholstered component finishing system and exemplary process in accordance with an embodiment of the present invention.

FIG. 5 illustrates another example of an upholstered component finishing system in accordance with one embodiment of the present invention.

FIG. 6 illustrates the system of FIG. 5 with a upholstered component removed from an inflatable bag and form area.

FIG. 7 illustrates the system of FIGS. 6-7 with an upholstered component in a rotated position relative to the inflatable bag and form area.

### DETAILED DESCRIPTION OF EMBODIMENTS

Various embodiments of the invention address some or all of the above issues and combinations thereof by providing methods, systems, and apparatus for finishing a vehicle seat component.

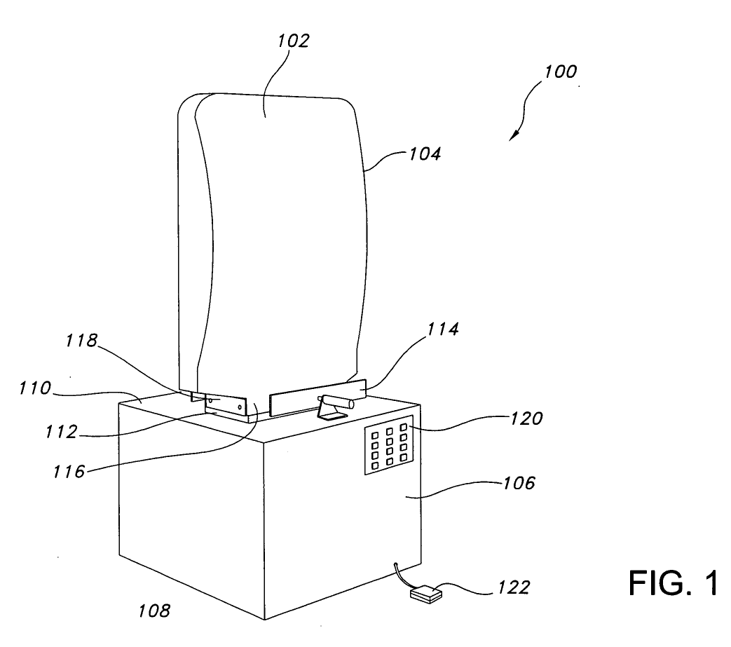

FIG. 1 is an exemplary an upholstered component, such as a vehicle seat finishing system in accordance with various embodiments of the invention. The system 100 shown is by way of example. An embodiment of a system in accordance with the invention will be manufactured and distributed by VEIT Americas of Winder, Ga. under the tradename “VEIT 8420 AutoSeat Finisher.” Other embodiments can include alternative components, fewer or greater numbers of components, or alternative arrangements of components. The system 100 shown in FIG. 1 can operate in a variety of environments, such as an assembly area or production line.

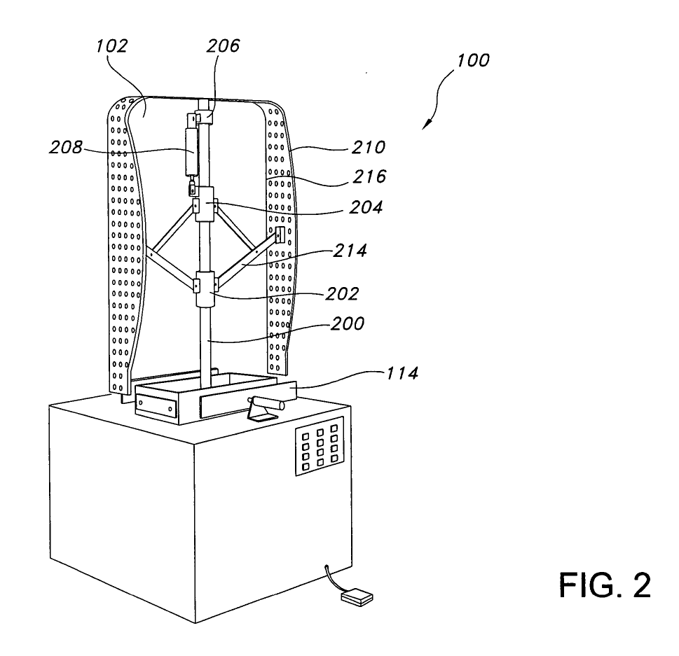

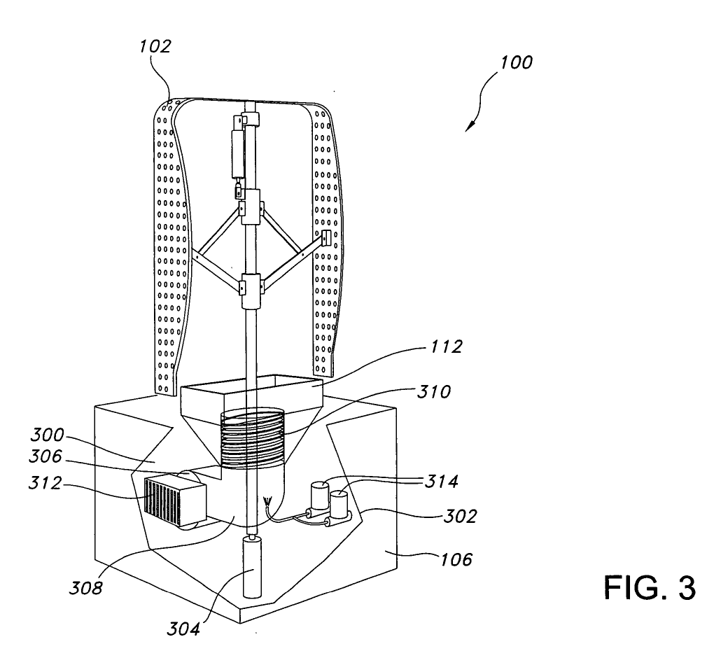

The system 100 is shown with a form area 102, an inflatable bag 104, and a base unit 106. The form area 102 is operable for receiving a vehicle seat component, such as a vehicle seat cover. Additional features of a form area 102 are shown and described with respect to FIG. 2. The inflatable bag shown in FIG. 1 can mount to and operate in conjunction with the form area 102. The inflatable bag 104 is operable to expand from a relatively smaller size to a relatively larger size. When the inflatable bag 104 is mounted to a portion of the form area 102, an upholstered component such as a seat cover can be, connected, mounted or otherwise associated to a portion of the inflatable bag 104. The form area 102 can be operated to inflate the inflatable bag 104, thereby stretching the seat component mounted to the inflatable bag 104. The base unit 106 can enclose or otherwise provide air or gas sub-system functionality, steam supply sub-system functionality, and other associated electronic and process controls for implementing an automated process, such as a finishing process for a vehicle seat component, with the form area 102 and inflatable bag 104. Additional features associated with a base unit 106 are shown and described with respect to FIG. 3. As shown in FIG. 1, the base unit 106 can be positioned on a relatively flat surface such as a floor or the ground 108. The form area 102 can mount to an upper surface 110 of the base unit 106, and can extend vertically from the upper surface 110 of the base unit 106. The inflatable bag 104 can be shaped as a vehicle seat component, such as a seat cover, and can mount to a portion of the form area 102.

In this particular embodiment, the inflatable bag 104 is shown contacted, mounted, or otherwise associated to the form area 102. A duct 112 can extend from the upper surface 110 of the base unit 106. The duct 112 is operable to provide air or another gas to a portion of the form area 102 to inflate the inflatable bag 104 mounted to the form area 102. The form area 102 can include a set of lower clamping plates, such as 114. The lower clamping plates 114 shown can be manipulated as needed to secure the position of the inflatable bag 104 with respect to the duct 112. One or more associated Velcro™ pieces 116, clamps 118, or other similar devices can be positioned adjacent to the duct 112 to secure corresponding portions of the inflatable bag 104 with respect to the duct 112.

In one embodiment, a system can include a series of front and rear rapidly exchangeable bottom clamping plates for holding a seat component, such as a vehicle seat cover, in position during a finishing process or cycle. The clamping plates can be operated via air cylinders with adjustable pressure and speed controls. These clamping plates can be covered with a soft silicon foam or needle fabric to reduce marking on the seat component. Additional clamping plates can be used for positioning and holding particular seat components that may be open on one side, such as a seat cushion cover or an open-back seat construction. These types of clamping plates can also be rapidly exchangeable and operated via air cylinders with adjustable pressure and speed controls.

External controls, such as a control system panel 120 and a foot pedal 122, can be mounted to a portion of the base unit 106 for access by a user, such as an operator. Other types of controls can include, but are not limited to, manually operated, optical controlled, voice controlled, or otherwise user operable or automated controls, can be mounted to or located adjacent to the base unit 106. In any instance, the use of external controls, such as control system panel 120 and a foot pedal 122, can provide a user with a variety of control and command functionality for use in conjunction with an automated process, such as a finishing process for a vehicle seat component.

In one embodiment, a foot pedal can provide one or more system and control inputs for a user such as an operator. For example, a foot pedal can include three pedals. A first pedal can control a series of clamping steps associated with the lower clamping plates, such as activating the closing of clamp assemblies in three steps. In this example, step one closes a rear clamp, step two closes a front clamp, and step three closes an upper rear clamp. A second pedal can provide a step backwards in a clamping or another process to correct a loading error. A third pedal can further control a series of clamping steps to operate the lower clamping plates to release a seat component. Other pedal configurations, functionality, or control commands can be accomplished by other embodiments of the invention.

In FIG. 2, a view of the system 100 is shown without an inflatable bag, such as 104 in FIG. 1, mounted to a portion of a form area, such as 102 in FIG. 1. In this example, the system 100 is capable of a tensioning process, and an inflating process. The system 100 can include a form area shown as 102, a tensioning pole 200, a series of mounting blocks 202, 204, 206, a tensioning device 208, and one or more form plates 210. Other embodiments can include alternative components, fewer or greater numbers of components, or alternative arrangements of components.

The tensioning pole 200 mounts to an upper surface 110 of an associated base unit 106. The tensioning pole 200 shown is capable of supporting one or more components used to provide a tension or other force to one or more form plates, such as 210. For example, in this embodiment, the tensioning pole 200 can support a series of mounting blocks 202, 204, 206, and a tensioning device 208. Form plates 210, such as a contoured, perforated form plates, can be mounted to the some or all of the components supported by the tensioning pole 200. The form plates 210 shown are capable of contacting or otherwise associating with an inflatable bag, such as 104 shown in FIG. 1. Ultimately, the form plates can be molded in the shape of a seat component, such as a seat cover. In this and other embodiments, form plates can be a single plate, multiple plates, or a series of integrated plates. Plates can be premolded to generally conform with a particular seat component to be utilized or otherwise processed with the system 100. Perforations throughout the form plates 210 are capable of permitting air, gas, and steam to pass through the form plates.

In this example, the form plates 210 can mount to extended arms 212, 214 associated with lower fixed mounting block 206. Various components, such as the series of mounting blocks 202, 204, 206, and the tensioning device 208, can mount to the tensioning pole 200 in a variety of arrangements. In the arrangement shown, mounting blocks 202 and 206 can remain fixed or stationary relative to the tensioning pole 200, and mounting block 204 can slide or otherwise move relative to the tensioning pole 200. Tensioning device 208 can mount between the upper fixed mounting block 202 and the sliding mounting block 204. When the tensioning device 208 is operated, the distance between the upper fixed mounting block 202 and the sliding mounting block 204 can be increased. When the sliding mounting block moves relative to the tensioning pole 200, a horizontal force can be applied to the extended arms 212, 214 associated with the lower fixed mounting block 206. Some or all of the horizontal force can then be transferred to an interior surface 216 of the form plates 210, thereby causing a portion of the form plates to move slightly away from the tensioning pole 200. Likewise, when the tensioning device 208 is operated to decrease the distance between the upper fixed mounting block 202 and the sliding mounting block 204, the sliding mounting block 204 can move relative to the tensioning pole 200 to decrease the horizontal force applied to the extended arms 212, 214 associated with the lower fixed mounting block 206. In this manner, various portions of the form plates 210 can be manipulated in a horizontal direction as needed.

The form plates 210 can also be subjected to a force in the vertical direction. One end of the tensioning pole 200 can be in contact with an interior surface of the form plate 210. A portion of the tensioning pole 200, such as an opposing end, can be mounted to a vertical load cylinder such as 304 shown in FIG. 3. The load cylinder 304 can be operated to elevate or lower the tensioning pole 200 in a vertical direction, thereby subjecting the form plates 210 to a vertical force as needed. In this manner, various portions of the form plates 210 can be manipulated in a vertical direction as needed.

In one embodiment, vertical tensioning of a seat component such as a vehicle seat cover can be provided by a direct air cylinder or via linkage with adjustable air pressure and speed controls. A form plate can be a rapidly exchangeable “shaped form plate” mounted to the upper portion of the vertical tensioning assembly. Horizontal tensioning of the seat component can be provided via a linkage system connected to an air cylinder with adjustable pressure and speed controls. Rapidly exchangeable “shaped” side section forms can be mounted to the horizontal tensioning system. The shaped forms can be manufactured from materials such as aluminum, stainless steel or high temperature engineered plastic materials. Other devices for providing a tensioning force can include other components in accordance with other embodiments of the invention.

When an inflatable bag, such as 104 in FIG. 1, is contacting, connecting, mounted, or otherwise associating to the form plates 210, the lower clamping plates 114 can be manipulated to secure the position of the inflatable bag relative to the form plates 210. As described and shown in FIG. 1, Velcro™ pieces, clamps, or other devices can be used to secure other portions of the inflatable bag relative to the form plates 210. Through operation of the tensioning pole 200 and the various components described above, horizontal and vertical forces can be applied to the form plates 210. Such forces can stretch or otherwise expand the inflatable bag mounted to the form plates 210. In addition, when a seat component such as a vehicle seat cover is mounted to a portion of the inflatable bag and form plates 210, operation of the tensioning pole 200 and the various components described above can stretch or otherwise expand the vehicle seat cover contacting, connected, mounted, or otherwise associated to the inflatable bag and form plates 210. Other devices for securing a position of a seat component can include other components in accordance with other embodiments of the invention.

In FIG. 3, a cutaway view of the base unit of system 100 is shown without an inflatable bag mounted to a portion of a form area. The base unit, shown as 106, can enclose or otherwise house some or all components of an air or gas fan sub-system 300, and a steam supply sub-system 302. The air or gas sub-system 300 is adapted to provide air or gas via a duct, such as 112, towards a form area, such as 102. The air or gas can inflate an inflatable bag, such as 104 shown in FIG. 1, mounted to a portion of the form area 102. While the inflatable bag 104 is in an inflated position, the steam supply sub-system is adapted to provide steam via the duct 112 towards the form area 102. The steam can increase the heat and permeate some or all of the inflatable bag 104. In this manner, a seat component such as a vehicle seat cover can be mounted to a portion of the inflatable bag 104 when the inflatable bag 104 is in a deflated position. When the inflatable bag 104 is inflated by the air or gas sub-system 300, the vehicle seat cover can be stretched or otherwise expanded. While the vehicle seat cover is being stretched or expanded, the steam supply sub-system 302 can provide steam and heat to the vehicle seat cover to remove any undesirable features in the material of the vehicle seat cover, such as wrinkles, creases, sewing pucker, marks, and the like.

In one embodiment, an inflatable but semi-porous airbag system can be used for inflation and for applying tension to an inner surface area of a seat component such as a vehicle seat cover. The air bag can be custom made and tailored to fit the seat component. The air bag can be produced from various fabrics to suit the types of seats being finished. In one example, for pile cloth seat covers, which can mark easily, a Teflon™ woven fabric can be used. The Teflon™ can reduce the surface contact temperature to eliminate marking or shine on the seat cover. In another example, for leather seat covers requiring a higher surface contact temperature, a nylon fabric or a fabric impregnated with aluminum flakes can be used. To obtain a seal around the base of the air bag, the bottom hem of the bag can be clamped or located with a Velcro type material against a locating duct, such as an air duct.

Other devices for inflating an inflatable bag or airbag, and providing steam and/or heat to a seat component can include other components in accordance with other embodiments of the invention.

In the example shown in FIG. 3, a base unit 106 can include a vertical load cylinder 304, a fan 306, air ducting 308, a steam coil 310, an auxiliary steam coil 312, and a series of steam spray valves 314. Some or all of these components can comprise the air or gas sub-system 300 and steam supply sub-system 302, which are integrated in this example to share the air ducting 308. Other embodiments can include alternative components, fewer or greater numbers of components, or alternative arrangements of components.

The base unit 106 shown can also include a programmable control unit or processor. The programmable control unit or processor can communicate with an output device such as a screen display or digital display. The programmable control unit or processor is adapted to control various functionality associated with the system 100 including, but not limited to, opening/closing of front and rear clamping plates, vertical and horizontal tensioning of one or more form plates, a steaming cycle, a steam-air combination cycle, an air or gas inflation or blowing cycle, an air volume control, one or more password protected stored programs (programs can vary according to seat component type and fabric content), program selection, an unloading cycle, and a production counter with reset function. In addition, other functionality or commands can be controlled by the programmable control unit or processor including, but not limited to, a total batch counter for machine renting/leasing purpose, 50/60 hz setting, motor min and max speeds, delay time for steam, delay time side (horizontal tensioning), and delay time vertical tensioning.

In a particular example, the programmable control unit or processor can include a set of instructions or software capable of controlling a steaming process or cycle associated with the system 100. For example, a steaming process can include operation of two automatic steam valves. Adjustable manual valves can be included with each automatic valve to allow reduction of the steam volume from each valve. In this manner, control of the automatic and manual steam valves can provide a variety of steam spray volume options. In one embodiment, the steam cycle can be adjustable from 0-30 seconds.

In another example, the programmable control unit or processor can include a set of instructions or software capable of controlling a combination air and steaming process or cycle associated with the system 100. For example, a combination air and steaming process can include simultaneously applied steam and air to the seat component. This can increase the overall tensioning from the air bag during the steaming cycle, as required by some seat component fabrics. In one embodiment, the steam/air cycle can be adjustable from 0-30 seconds.

In yet another example, the programmable control unit or processor can include a set of instructions or software capable of controlling an air process or cycle associated with the system 100. For example, an air process can include blowing air via motorized impeller fan with a velocity of approximately 4.0 inches water column. The air can be passed through a minimum of one steam heated coil assembly for heating. The air volume can be controlled (0-100%) and may also be further controlled via use of a manual baffle device mounted within the air-duct system. The air temperature can be adjustable by varying the steam supply pressure to heating coil by the use of a pressure regulator. In one embodiment, the air cycle time can be adjustable from 0-30 seconds.

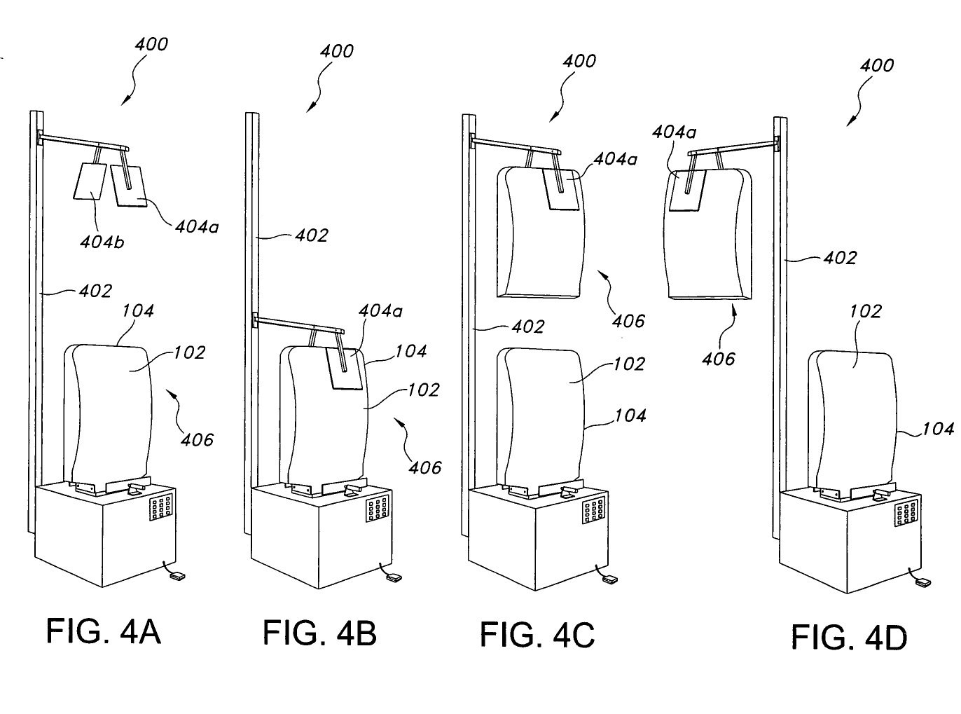

FIGS. 4A-4D illustrate an associated system and process for use with the system shown in FIGS. 1-3 in accordance with an embodiment of the invention. The associated system 400 is capable of gripping or otherwise unloading a seat component, such as a vehicle seat cover, mounted to a portion of an inflatable bag and form area, for example, inflatable bag 104 and form area 102 shown in FIGS. 1-3. The associated system 400 can include a mounting post 402, and a set of gripper pads 404a-b.

As shown in FIG. 4A, the associated system 400 can operate in conjunction with the system 100 shown in FIGS. 1-3. Prior to or during the expansion, heating, and steaming of a seat component 406 mounted to an inflatable bag 104 and form area 102 associated with system 100, the set of gripper pads 404a-b can be positioned above the seat component 406 in an open position. After the seat component 406 has been subjected to expansion, heating, and steaming, the inflatable bag 104 can be deflated, and any vertical or horizontal forces applied to the form area 102 have been decreased, then the seat component 406 can be removed from the inflatable bag 104 and form area 102.

As shown in FIG. 4B, the set of gripper pads 404a-b can be lowered to contact an outer surface of the seat component 406. In this example, gripper pads 404a-b are positioned on opposing sides of the seat component 406. The gripper pads 404a, 404b can move slightly towards each other to increase the contact friction with the outer surface of the seat component 406. In one embodiment, the gripper pads 404a-b can include an adhesive or other material to grip the outer surface of the seat component 406. When suitable contact between the gripper pads 404a-b and the outer surface of the seat component 406 is established, the set of gripper pads 404a-b can be elevated with the seat component 406 as shown in FIG. 4C.

Referring to FIG. 4C, as the set of gripper pads 404a-b are elevated, the seat component 406 can be removed from the inflatable bag 104 and form area 102. The set of gripper pads 404a-b and seat component 406 can be elevated to an elevated position over the inflatable bag 104 and form area 102.

In FIG. 4D, the set of gripper pads 404a-b and seat component 406 can be rotated away from the inflatable bag 104 and form area 102 to a rotated position relative to the inflatable bag 104 and form area 102. In this position, a user such as an operator can remove the seat component 406 from the set of gripper pads 404. In one embodiment, a device or a collection system can remove the seat component 406 from the set of gripper pads 404a-b.

In one embodiment, an associated system such as an unloading system can include a clamping device mounted to a vertical guide controlled by a standard or rod-less cylinder. The unloading system can be activated or otherwise operated at the end of a machine or finishing process or cycle. An associated carriage on the guide (rod-less) cylinder can move downward until it reaches a lower end switch. The clamping device can close and grip the seat component between the clamps. The carriage, operated by a (rod-less) cylinder, can lift or otherwise unload the seat component off an associated finishing unit, such as an inflatable bag and form area, and can move upwards until it reaches an upper end switch. The clamping device can then be rotated approximately 90° to where the seat component can clears an upper area of the inflatable bag and form area for loading of the next seat component. A user such as an operator can then operate or otherwise step on an associated foot pedal to release the seat component from the clamping device. The clamping device can rotate back to an initial or home position until signaled, or otherwise controlled or instructed, to remove the next seat component. Other devices for unloading or removing a seat component can include other components in accordance with other embodiments of the invention.

In other embodiments of the invention, a system such as 100 and associated system 400 can be in communication with a client device such as a computer or processor-based device capable of communicating with the communications network via a signal, such as a wireless frequency signal or a direct wired communication signal. Some or all of the functionality associated with the programmable control unit or processor described above can be implemented with a client device.

In this particular embodiment, each client device can include a processor and a computer-readable medium, such as a random access memory (RAM), coupled to the processor. The processor can execute computer-executable program instructions stored in memory. Such processors may comprise a microprocessor, an ASIC, and state machines. Such processors comprise, or may be in communication with, media, for example computer-readable media, which stores instructions that, when executed by the processor, cause the processor to perform the steps described herein. Embodiments of computer-readable media include, but are not limited to, an electronic, optical, magnetic, or other storage or transmission device capable of providing a processor, such as the processor, with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Client devices may also comprise a number of external or internal devices such as a mouse, a CD-ROM, DVD, a keyboard, a display, or other input or output devices. A client device can be in communication with an output device, such as a display screen. Examples of client devices are personal computers, mobile computers, handheld portable computers, digital assistants, personal digital assistants, cellular phones, mobile phones, smart phones, pagers, digital tablets, desktop computers, laptop computers, Internet appliances, and other processor-based devices. In general, a client device may be any type of processor-based platform that is connected to a network and that interacts with one or more application programs. Client devices may operate on any operating system capable of supporting a browser or browser-enabled application, such as Microsoft® Windows® or Linux. The client devices shown include, for example, personal computers executing a browser application program such as Microsoft Corporation's Internet Explorer™, Netscape Communication Corporation's Netscape Navigator™, and Apple Computer, Inc.'s Safari™.

A user, such as an operator, can interact with a client device via an input device (not shown) such as a keyboard or a mouse. For example, a user can input information, such as process instructions or commands via the client device by keying text via a keyboard or inputting a command via a mouse, or using a stylus or using a bare finger.

A user such as an operator can receive output, such as control information, from an output device, such as a display screen, via a client device. Other types of output devices can include, but are not limited to, plasma displays, LCD displays, and touch screen devices.

The system 100 and associated system 400 can also be in communication with a server in communication with the network. The server can include memory and a finishing process application program, also known as a finishing process engine. Information associated with finishing a seat component such as a vehicle seat cover can be received by the server via the network from one or more client devices, a database or other data storage devices, or from other information systems.

Similar to the client devices, the server device can comprise a processor coupled to a computer-readable memory. The server device can be in communication with a database, or other data storage device. The database can receive and store data from the server, or from a client via the network. Data stored in the database can be retrieved by the server or clients as needed.

Server device can be a single computer system, or may be implemented as a network of computer processors. Examples of a server device are servers, mainframe computers, networked computers, a processor-based device, and similar types of systems and devices. Client processor and the server processor can be any of a number of computer processors, such as processors from Intel Corporation of Santa Clara, Calif. and Motorola Corporation of Schaumburg, Ill. The computational tasks associated with rendering the graphical image could be performed on the server device(s) and/or some or all of the client device(s).

The server device can integrate with and can communicate with other information systems to receive information, such as real time events associated with one or more processes. Such real time events or other information can be stored in the database or other data storage device to support real time and dynamic updating of information displayed on some or all of the output devices.

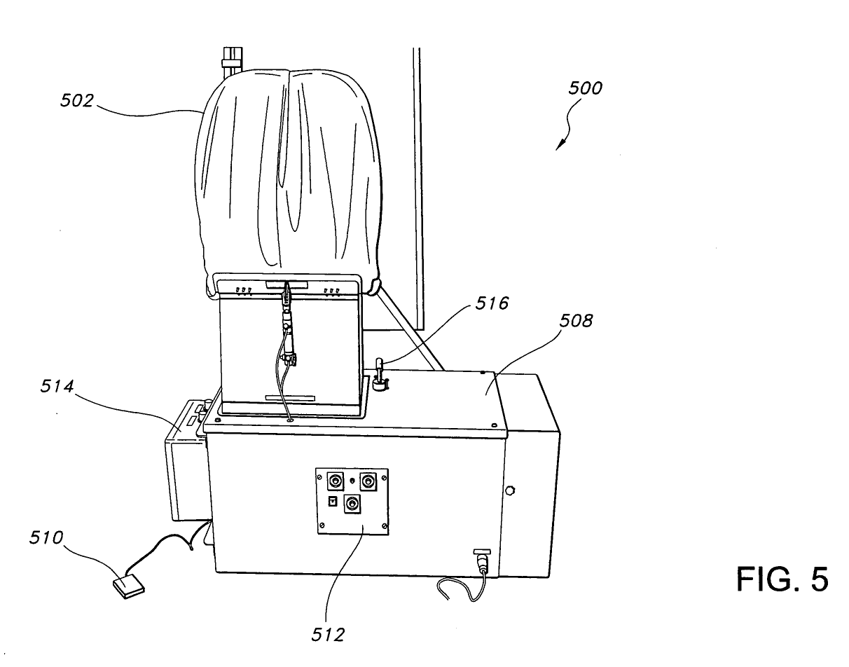

FIGS. 5-7 illustrate another example of a system in accordance with an embodiment of the invention. Some or all of the features, aspects, and functionality associated with the system shown in FIGS. 5-7 are similar to those described and shown with respect to the system of FIGS. 1-4. In addition, some or all of the elements of method described above can be performed by the system shown in FIGS. 5-7.

FIGS. 5-7 illustrate one embodiment of a vehicle seat finishing system 500 with a seat component 502, a form area 504 and an inflatable bag 506. A base unit 508 is provided that includes controls, such as a foot pedal control 510, a control system panel 512, a control box 514, and a hand control 516. The form area 504 can be operated to inflate the inflatable bag 506 to stretch the seat component 502. The base unit 508 can enclose and/or provide air, gas, steam, or otherwise to inflate the inflatable bag 506 using the form area 504.

In FIG. 5, a seat component 502 is shown having a wrinkled or otherwise unfinished surface. The seat component 502 is around a form area (not shown) and an inflatable bag (not shown). An operator can use one or more of the controls to direct the base unit 508 to inflate the inflatable bag 506 using the form area 504. The inflatable bag 506 will expand and stretch the seat component 502 to create a finished surface.

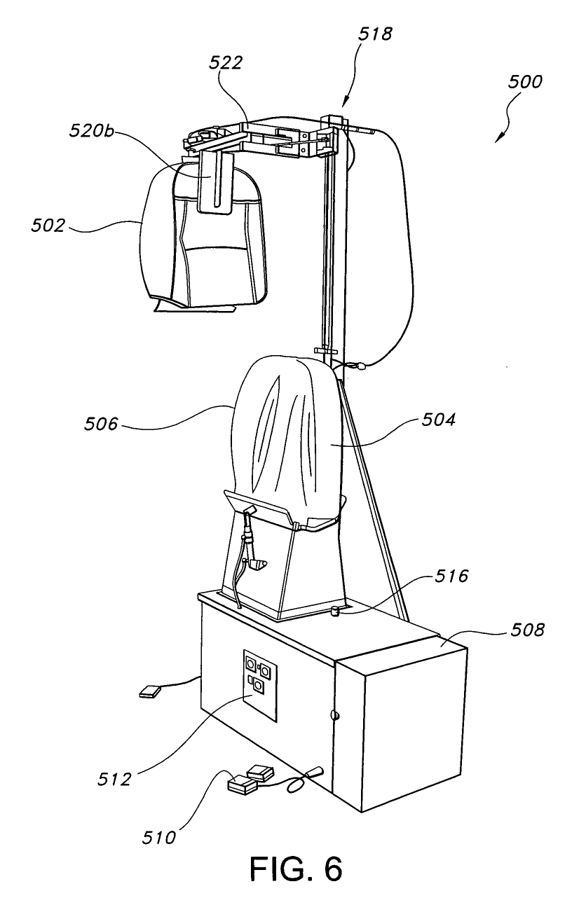

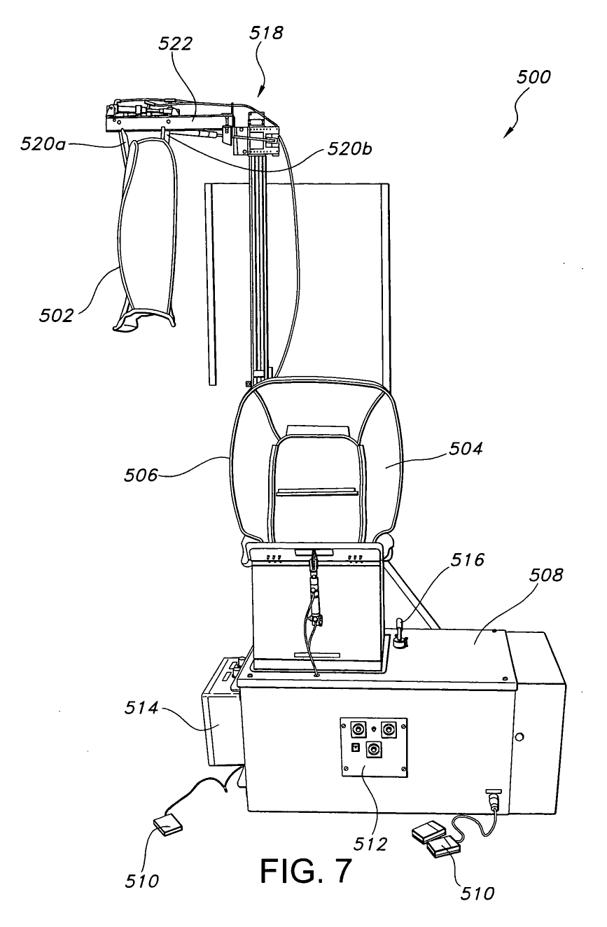

FIGS. 6-7 shows a seat component 502 removed from the form area 504 and inflatable bag 506 after the creating the finished surface on the seat component 502. The seat component 502 may be removed using an apparatus 518. The apparatus 518 may include gripper pads 520a-b and a control arm 522 that may be used to position and control the gripper pads 520a-b to move and/or release the seat component 502. The control arm 522 may be controlled using the controls included on the base unit 508. As shown in FIG. 7, the seat component 502 may be rotated using the control arm 522 to a rotated position relative to the form area 504 and inflatable bag 506. An operator may then remove the finished seat component.

While the above description contains many specifics, these specifics should not be construed as limitations on the scope of the invention, but merely as exemplifications of the disclosed embodiments. Those skilled in the art will envision many other possible variations that within the scope of the invention as defined by the claims appended hereto.

What is claimed is:

1. A system for finishing an upholstered component comprising:
an inflatable bag for connecting to the upholstered component;
a form area for connecting to the inflatable bag;
a gas system for providing a gas to inflate the inflatable bag, the inflatable bag being adapted to stretch the upholstered component;
a tensioning system for providing a force on the form area; and
a steam supply system for providing steam to the upholstered component.

2. The system of claim 1, further comprising:
a base unit associated with the inflatable bag and the form area comprising at least one control for operating the system.

3. The system of claim 2, wherein the control is a foot pedal.

4. The system of claim 2, wherein the base unit further comprises
a duct for providing gas or steam to a portion of the form area; and
clamping plates to assist in securing the inflatable bag;

5. The system of claim 1, wherein the tensioning system comprises:
a pole mounted to an upper surface of a base unit, the pole supporting a mounting block, at least one form plate, and a tensioning device;
wherein the mounting block is operable to move the mounting block relative to the pole.

6. The system of claim 1, further comprising clamping plates for controllably positioning and holding the upholstered component.

7. The system of claim 1, wherein the gas is air.

8. A method for finishing a upholstered component comprising:
positioning the upholstered component to an inflatable bag and a form area, wherein the upholstered component is positioned substantially adjacent to the inflatable bag;
securing a position of the upholstered component relative to the inflatable bag and the form area;
providing a tensioning force to the form area, wherein a portion of the tensioning force is applied to the upholstered component;
providing gas to the inflatable bag, wherein a portion of the gas is applied to the upholstered component;
applying steam to the upholstered component; and
wherein the application of the tensioning force, air, and steam is applied to the upholstered component.

9. The method of claim 8, further comprising:
providing a base unit for supporting the form area and inflatable bag.

10. The method of claim 8, wherein the gas is air.

11. The method of claim 8, further comprising holding the upholstered component in position.

12. The method of claim 8, wherein providing the tensioning force to the form area comprises a horizontal force and a vertical force.

13. The method of claim 12, wherein applying the horizontal force comprises increasing a distance between a sliding mount block and a fixed mounting block.

14. The method of claim 12, wherein applying the vertical force comprises changing the vertical position of a tensioning pole having form plates in contact with the form area.

15. The method of claim 8, further comprising providing gripper pads to remove the upholstered component relative to the inflatable bag and form area.

16. The method of claim 8, wherein the application of the tensioning force, air, and steam is simultaneously applied to the upholstered component

17. A system comprising:
an inflatable bag, a form area, a gas system, a tensioning system, and a steam supply system for finishing an upholstered component;
at least one gripper pad movably connected to a mounting post, the at least gripper pad being adapted to grip an outer surface of the upholstered component mounted to the inflatable bag and form area;
wherein the at least one gripper pad demounts the upholstered component from the inflatable bag and form area when the at least one gripper pad is elevated relative to the mounting post.

18. The system of claim 17, wherein the at least one gripper pad is adapted to rotate to a rotated position relative to the inflatable bag and form area.

19. The system of claim 17, wherein the at least one gripper pad comprises two gripper pads.

20. The system of claim 19, wherein the two gripper pads grip the outer surface of the upholstered component by moving towards each other.

21. The system of claim 17, further comprising a base unit comprising a control for controlling the at least one gripper pad.
